(19) United States
(12) Patent Application Publication
(10) Pub. No.: US 2015/0109894 A1
(43) Pub. Date: Apr. 23, 2015

(54) OPTICAL RECORDING DEVICE AND OPTICAL RECORDING METHOD

(71) Applicant: TAIYO YUDEN CO., LTD., Tokyo (JP)

(72) Inventors: Kenichi Shimomai, Takasaki-shi (JP); Yutaka Imamura, Takasaki-shi (JP)

(73) Assignee: TAIYO YUDEN CO., LTD., Tokyo (JP)

(21) Appl. No.: 14/399,801

(22) PCT Filed: May 13, 2013
(86) PCT No.: PCT/JP2013/063252

§ 371 Date: Nov. 7, 2014

(30) Foreign Application Priority Data
May 15, 2012 (JP) 2012111804

(51) Int. Cl. G11B 7/007; G06F 3/06

(52) U.S. Cl. CPC G11B 7/00736; G06F 3/0604; G06F 3/0638; G06F 3/0677
USPC 369/47.15

(57) ABSTRACT

An optical recording device for recording to a disk having a guide layer and a plurality of recording layers includes a controller which obtains, by calculation, logical addresses of data areas of all recording layers on the basis of physical addresses of a guide layer and recording layer information. Specifically, in treating the maximum value (last physical address) of physical addresses in the guide layer as PSN_max, recording layer information of recording layer Lx as x (x=0, 1, 2, . . . ), physical addresses corresponding to recording destination positions in the data area of recording layer Lx as PSN, and logical addresses imparted to data units recorded at recording destination positions in the data area of recording layer Lx as LSN, calculation for LSN=(PSN_max*x)+PSN . . . (1) is performed.

### TECHNICAL FIELD

The present invention relates to an optical recording device and optical recording method involving recording to a multi-layer disk having a guide layer and multiple recording layers.

### BACKGROUND ART

Optical disks such as DVDs (digital versatile disks) and Blu-ray Discs (registered trademark) are given multiple recording layers for the purpose of increasing their capacity. As these disks now have multiple layers, a tracking control method is known whereby data is recorded to or played back from the recording layers using guide tracks provided in a layer different from the recording layers. For example, optical drive devices, etc., are available that perform tracking control using light of 390 nm to 420 nm in wavelength (blue) to a guide tracking layer having grooved guide tracks provided in it, and record data to one of multiple recording layers using light of 650 nm to 680 nm in wavelength (red) (refer to Patent Literature 1, for example).

### PRIOR ART LITERATURES

### Patent Literatures

### Patent Literature 1: Japanese Patent Laid-open No. 2007-200427

### SUMMARY OF THE INVENTION

### Problems to be Solved by the Invention

DVDs and other write-once disks adopt the wobble modulation method for recording physical addresses onto recording tracks. Under the wobble modulation method, recording tracks are formed by meandering guide grooves and these meanderings (wobbles) are frequency-modulated or phase-modulated, etc., to record physical addresses. When recording data to a disk, the disk drive obtains the applicable physical address (sector number) by demodulating the wobbles and generates an ID (identification data) containing this physical address as the logical address of the recording data frame, and records this ID to the disk together with the user data, etc., for recording. Then, when the disk drive receives a read command with the logical address specified by the host device, the disk drive converts the logical address to a physical address, reads the user data at the corresponding position on the disk, and transfers the data to the host device.

In the case of a multi-layer disk having a guide layer and multiple recording layers, however, the ability to constitute each recording layer with a flat surface is considered a manufacturing advantage, and it is therefore not assumed that guide grooves to which physical addresses are recorded by the wobble modulation method are provided like DVDs. This gives rise to the question, when a recording data frame is to be recorded to the recording layer, of how to obtain the logical address assigned to this recording data frame and how to generate a logical address from the physical address obtained.

In light of the aforementioned situation, an object of the present invention is to provide an optical recording device and optical recording method that can assign consecutive logical addresses in a favorable manner to the data areas of all recording layers of a multi-layer disk having a guide layer and multiple recording layers, while improving the manufacturing yield of multi-layer disks at the same time.

### Means for Solving the Problems

To achieve the aforementioned object, the optical recording device pertaining to an embodiment of the present invention is an optical recording device for recording to a disk that has at least one guide layer with a guide track where physical address information is recorded, and multiple recording layers where data is recorded according to the guide track, wherein such optical recording device has a physical address playback part that obtains the physical address information from the guide track in the guide layer, as well as a control part that uses the obtained physical address information and information identifying each of the recording layers to calculate the logical address to be assigned to each data recorded to the recording layer.

With the optical recording device proposed by the present invention, logical addresses of the data areas of multiple recording layers are generated, by means of calculation, from the physical addresses in the guide layer and the recording layer information. As a result, the manufacturing yield of multi-layer disks can be improved over the method of recording physical addresses beforehand in individual recording layers in the forms of wobbles or pit arrays and then utilizing these physical addresses to generate logical addresses for each recording layer when user data is recorded. To be specific, in the case of optical disks with physical addresses recorded in each recording layer in the forms of wobbles, pre-pits, etc., those disks having even a single recording layer that generates a physical address read error must be judged defective and scrapped. This means that increasing the number of recording layers to be stacked increases the percent defective of such multi-layer disks; while in this embodiment, all that is required is to read the physical addresses from the guide layer, and consequently the number of recording layers can be increased relatively easily and the manufacturing yield is also expected to improve.

Additionally, in the present invention, the control part may calculate LSN using the equation LSN=(PSN_max*x)+PSN, where PSN_max represents the largest physical address recorded in the guide tracks, x represents the information identifying recording layer Lx (x=0, 1, 2, etc., assigned in this order from the recording layer closest to or farthest away from the guide layer), PSN represents the physical address corresponding to the target recording position in the data area of recording layer Lx, and LSN represents the logical address assigned to each data that has been recorded at the target recording position in the data area of recording layer Lx.

Additionally, in the present invention, the guide layer may comprise a first guide layer having a first guide track and a second guide layer having a second guide track that spirals in the direction opposite the spiraling direction of the first guide track, where one physical address space is assigned to both the first guide track and second guide track combined, with the physical addresses recorded in the first guide track marking the starting side, and the control part may calculate LSN0 and LSN1 using the equations LSN0=(PSN_max*x)+PSN0 and LSN1=(PSN_max*(x−1))+PSN1, respectively, where PSN_max represents the largest physical address recorded in the first guide track, x represents the information identifying recording layer Lx (x=0, 1, 2, etc., assigned in this order from the recording layer closest to or farthest away from the first guide layer), PSN0 represents the physical address in the first guide track corresponding to the target recording position in the data area of even-numbered recording layer Lx (x=0, 2, etc.), PSN1 represents the physical address in the second guide track corresponding to the target recording position in the data area of odd-numbered recording layer Lx (x=1, 3, etc.), LSN0 represents the logical address given to each data recorded at the target recording position in the data area of even-numbered recording layer Lx (x=0, 2, etc.), and LSN1 represents the logical address given to each data recorded at the target recording position in the data area of odd-numbered recording layer Lx (x=1, 3, etc.).

Furthermore, in the present invention, the guide layer may comprise a first guide layer having a first guide track and a second guide layer having a second guide track that spirals in the direction opposite the spiraling direction of the first guide track, where the physical addresses recorded in the first guide track increase in the spiraling direction in one physical address space, while the physical addresses recorded in the second guide track decrease in the spiraling direction in the physical address space, and the control part may calculate LSN0 and LSN1 using the equations LSN0=(PSN_max*x)+PSN0 and LSN1=(PSN_max*x)+PSN_max−PSN1+1, respectively, where PSN_max represents the largest physical address recorded in the first guide track, x represents the information identifying recording layer Lx (x=0, 1, 2, etc., assigned in this order from the recording layer closest to or farthest away from the first guide layer), PSN0 represents the physical address in the first guide track corresponding to the target recording position in the data area of even-numbered recording layer Lx (x=0, 2, etc.), PSN1 represents the physical address in the second guide track corresponding to the target recording position in the data area of odd-numbered recording layer Lx (x=1, 3, etc.), LSN0 represents the logical address given to each data recorded at the target recording position in the data area of even-numbered recording layer Lx (x=0, 2, etc.), and LSN1 represents the logical address given to each data recorded at the target recording position in the data area of odd-numbered recording layer Lx (x=1, 3, etc.).

The optical recording method pertaining to another embodiment of the present invention is a method of recording to a disk having at least one guide layer with a guide track where physical address information is recorded, and multiple recording layers where data is recorded according to the guide track, wherein such method comprises a step to obtain the physical address information from the guide track in the guide layer, and a step to use the obtained physical address information and information identifying each of the recording layers to calculate the logical address to be assigned to each data recorded to the recording layer.

### Effects of the Invention

As explained above, according to the present invention it is possible to assign consecutive logical addresses in a favorable manner to the data areas of all recording layers of a multi-layer disk having a guide layer and multiple recording layers, while improving the manufacturing yield of multi-layer disks at the same time.

### BRIEF DESCRIPTION OF THE DRAWINGS

FIG. 1 A drawing showing the optical recording system pertaining to an embodiment of the present invention.

FIG. 2 A drawing showing the structures of the storage unit, disk cartridge, and drive unit of the optical recording system in FIG. 1.

FIG. 3 A section view showing the structure of an optical recording medium with guide layer.

FIG. 4 A drawing showing the structures of the areas, divided at radial-direction positions, in the guide layer and recording layer of the optical recording medium with guide layer.

FIG. 5 A drawing showing the structure of the disk drive of the optical recording system in FIG. 1.

FIG. 6 A drawing showing the data frame structure.

FIG. 7 A drawing showing the ID structure of the data frame in FIG. 6.

FIG. 8 A drawing showing the relationships between the physical addresses in the data area of the guide layer on one hand, and the logical addresses assigned to the data area of each recording layer on the other, according to the first embodiment of the present invention.

FIG. 9 A drawing showing the specific assignments of logical addresses according to the first embodiment.

FIG. 10 A drawing explaining the second embodiment of the present invention as well as the structure of the multi-layer disk in the second embodiment.

FIG. 11 A drawing showing the relationships between the physical addresses in the data areas of two guide layers on one hand, and the logical addresses assigned to the data areas of four recording layers on the other, according to the second embodiment.

FIG. 12 A drawing showing the physical addresses assigned to two guide layers according to the second embodiment.

FIG. 13 A drawing showing the specific assignments of logical addresses according to the second embodiment.

FIG. 14 A drawing showing the relationships between the physical addresses in the data areas of two guide layers on one hand, and the logical addresses assigned to the data area of each recording layer on the other, according to the third embodiment of the present invention.

FIG. 15 A drawing showing the physical addresses assigned to two guide layers according to the third embodiment.

FIG. 16 A drawing showing the specific assignments of logical addresses according to the third embodiment.

### MODE FOR CARRYING OUT THE PRESENT INVENTION

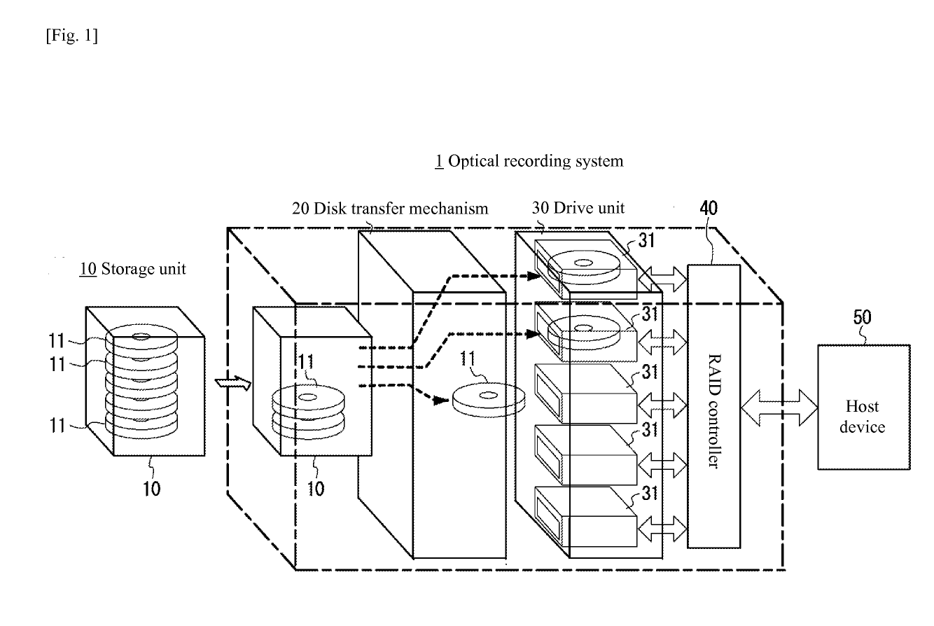

Embodiments of the present invention are explained below by referring to the drawings. FIG. 1 is a drawing showing the optical recording system pertaining to the first embodiment of the present invention.

FIG. 1 is a drawing showing the overall structure of the optical recording system. This optical recording system 1 comprises a storage unit 10, disk transfer mechanism 20, drive unit 30, RAID controller 40, and host device 50. They are each explained in detail below.

### [Storage Unit 10]

The storage unit 10 is a unit in which to store, in a separately and freely settable/removable manner, multiple optical disks 11 that are each a multi-layer optical recording medium.

Multiple optical disks 11 may be stored in the storage unit 10 in a flat stack pattern, single vertical file pattern, etc. Regardless of the pattern, preferably a certain clearance is provided between adjacent optical disks 11 for smooth insertion and removal of the optical disks 11 into/from the storage unit 10. The storage unit 10 may have a rectangular solid shape or cylindrical shape, for example, from the viewpoints of ease of handling by the user, storage efficiency of optical disks 11, and so on. In the example of FIG. 1, a rectangular solid storage unit 10 in which multiple optical disks 11 are stored in a flat stack pattern is used.

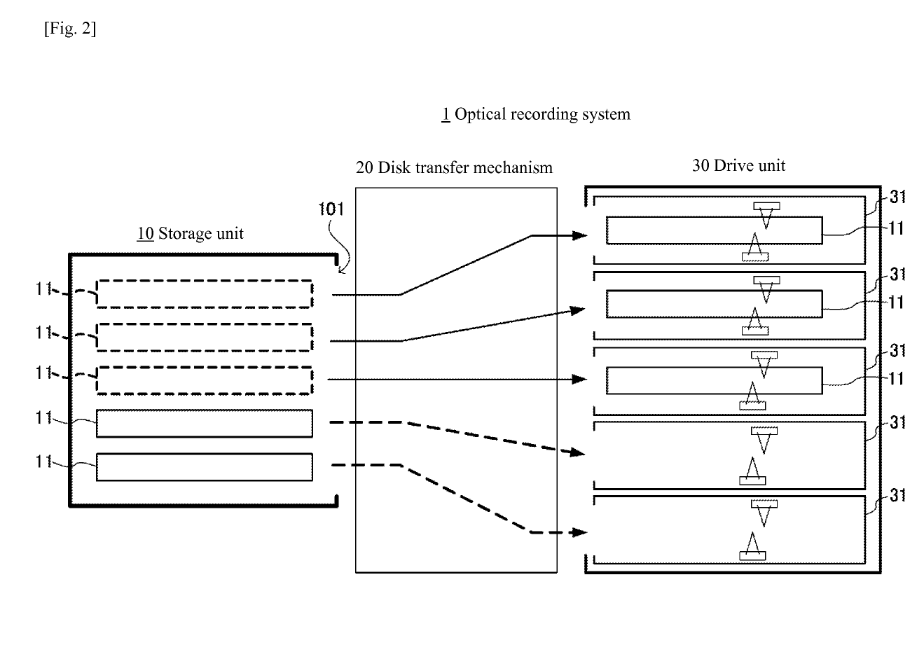

FIG. 2 is a drawing showing the structures of the storage unit 10, optical disks 11, and drive unit 30. Provided on at least one side face of the storage unit 10 are an opening 101 for inserting and removing optical disks 11 and a door (not illustrated) that opens and closes this opening 101. The door opens and closes in conjunction with the optical disk 11 insertion and removal operations of the disk transfer mechanism 20 into/from the storage unit 10, and remains closed at all other times.

Note that under the present invention, the structure of the storage unit 10 is not limited to the one shown in FIG. 2. Numerous variations are possible in terms of the shape of the storage unit 10, number and positions of openings, whether or not a door is provided, and storage pattern of multiple optical disks 11, among others.

### [Optical Disk 11]

The optical disks 11 stored in the storage unit 10 are each a so-called “optical disk with guide layer” having a guide layer and recording layers formed discretely as different layers. Particularly in this embodiment, a double-sided recording optical disk comprising two optical disks with guide layer attached together, and a single-sided recording optical disk that uses one optical disk with guide layer on its own are used. The double-sided recording optical disk and single-sided recording optical disk are hereinafter abbreviated as the “double-sided disk” and “single-sided disk,” respectively.

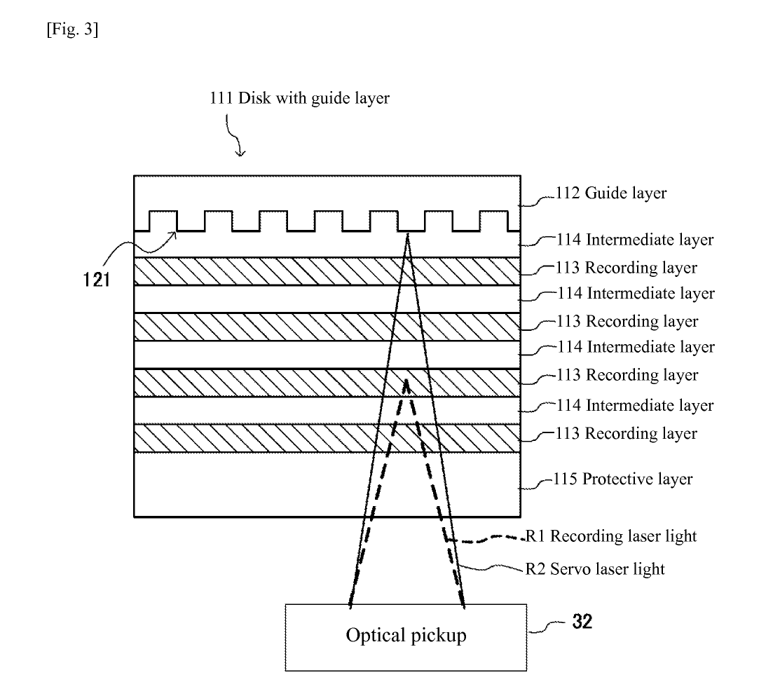

FIG. 3 is a section view showing the structure of an optical disk with guide layer 111. The optical disk with guide layer 111 has a guide layer 112 and multiple recording layers 113. In the example of optical disk with guide layer 111 in this figure, the number of recording layers 113 is 4. An optically transparent intermediate layer 114 is present between the guide layer 112 and the closest recording layer 113 and between each pair of adjacent recording layers 113. These layers are arranged as follows from the side through which the recording/playback light R1 and guide light R2 enter from the optical pickup 32: A protective layer 115, recording layer 113, intermediate layer 114, recording layer 113, intermediate layer 114, recording layer 113, intermediate layer 114, recording layer 113, intermediate layer 114, and guide layer 112.

On the side of the guide layer 112 facing the recording layer 113, guide tracks 121 of land-groove structure are provided in a spiral or concentric circle pattern for the purpose of tracking control. Formed on the sidewalls of guide tracks 121 via wobble modulation is physical address information indicating the track position information all around the disk. The guide tracks 121 are formed, for example, at a track pitch (0.64 μm) corresponding to the red laser light used for DVD (digital versatile disk) recording and playback. The average land-groove pitch is 0.32 μm. The red laser light is hereinafter referred to as the “guide light.”

With the optical recording system 1 of this embodiment, tracking control is implemented separately for the lands and grooves of guide tracks 121 according to the differential push-pull (DPP) method, for example. Implementing tracking control separately for the lands and grooves of guide tracks 121 makes it possible to record information to the recording layer 113 at a track pitch of 0.32 μm.

The recording layer 113 is where information is recorded, for example, at a track pitch (0.32 μm) corresponding to the blue laser light used for Blu-ray Disc (registered trademark) recording and playback. This blue laser light is hereinafter referred to as the “recording/playback light” or “recording light.” The recording layer 113 comprises an optical absorption layer, reflection layer, etc., for example. For the optical absorption layer, cyanine pigment, azo pigment and other organic pigments, as well as Si, Cu, Sb, Te, Ge, and other inorganic materials, are used. When the recording light is irradiated onto the target recording layer 113 of the optical disk with guide layer 111, the reflectance of the area over which the recording light was irradiated changes, and as the area whose reflectance has changed is formed as a pit, information is recorded to the recording layer 113.

Since tracking control is implemented and physical addresses and reference clock signals acquired using the guide tracks 121 in the guide layer 112 when information is recorded to or played back from the recording layer 113, the recording layer 113 need not have guide tracks 121 of land-groove structure. This means that the recording layer 113 can have a flat surface.

The optical disk 11 classified as a double-sided disk comprises two optical disks with guide layer 111 attached together, with the sides of the guide layers 112 opposite the land-groove structure sides facing each other.

FIG. 4 is a drawing showing the structures of the areas, divided at radial-direction positions, in the guide layer 112 and recording layer 113 of the optical disk with guide layer 111. The guide layer 112 and recording layer 113 are both divided commonly into the lead-in area, data area, and lead-out area, from the inner periphery side, divided at radial-direction positions.

In the lead-in area of the guide layer 112, management information unique to the optical disk with guide layer 111 has been pre-recorded by means of wobble modulation, etc. The management information unique to the optical disk with guide layer 111 includes the number of recording layers, recording method, recording line speed, recommended information such as the laser power and laser drive pulse waveform to be applied at the time of recording or playback, position information of the data area, position information of the OPC area, etc.

In the data area of the guide layer 112, physical address information assigned to the data area has been pre-recorded by means of wobble modulation, etc., of the grooves of guide tracks 121. Note that information identical to the information recorded in the lead-in area may have been pre-recorded in the lead-out area of the guide layer 112 by means of wobble modulation, etc.

The lead-in area of the recording layer 113 is where management information used for recording and playback to/from the recording layer 113 is recorded in the form of a pit array. Management information used for recording and playback to/from the recording layer 113 includes the layer number or other layer information assigned to the recording layer 113, replacement management information relating to the process for replacing missing areas, recording and playback conditions such as optimal laser power for recording determined by the OPC process (calibration process), etc.

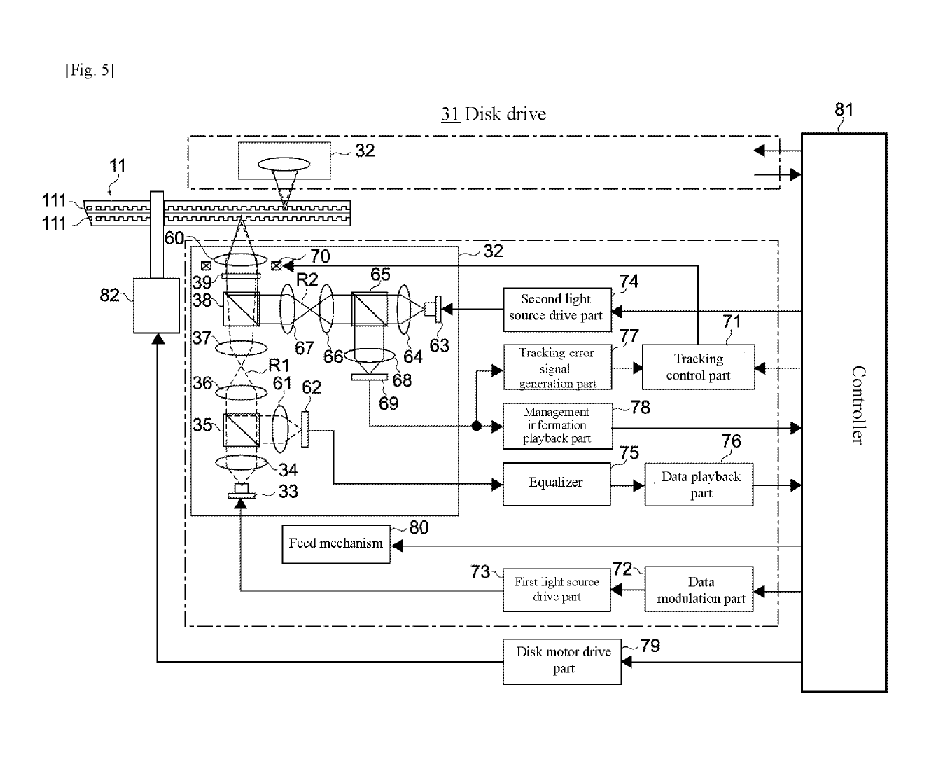

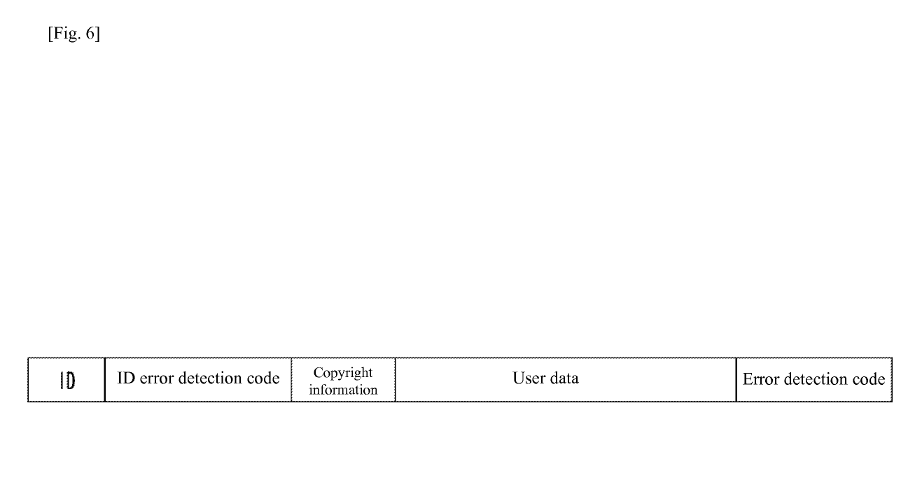

User data is recorded to the data area of the recording layer 113. User data is recorded in units of structures called “data frames.” FIG. 6 is a drawing showing the data frame structure. As shown in this figure, the data frame comprises the disk ID (identification data), ID error detection code, copyright information, user data, and error detection code, from the head.

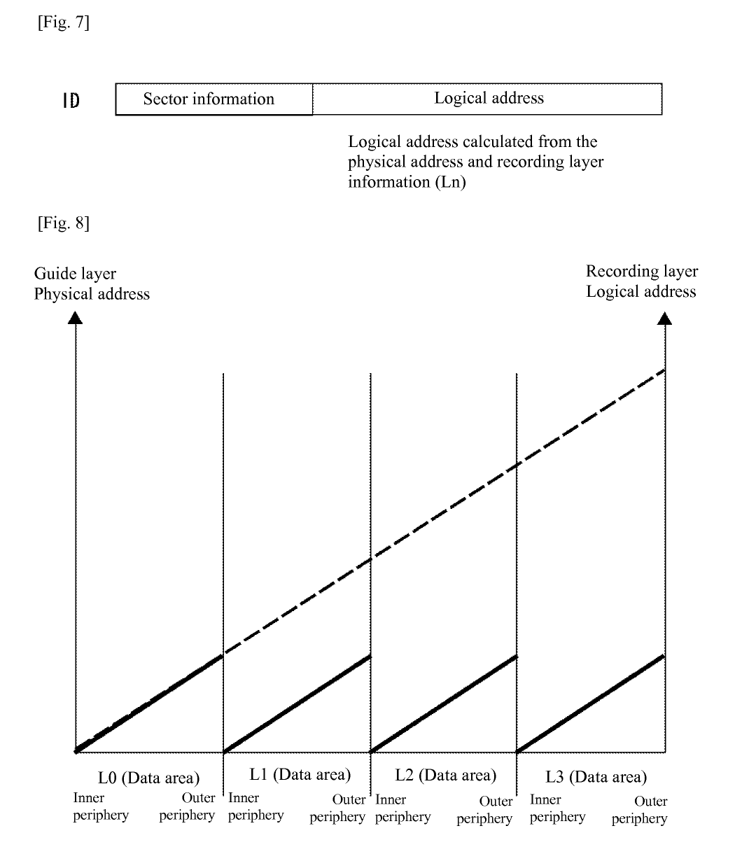

FIG. 7 is a drawing showing the ID structure. The ID comprises the sector information and logical address. The sector information contains the disk layer number information and recording layer information (layer information).

The disk layer number information indicates the number of recording layers provided on one side of the optical disk with guide layer 111.

The recording layer information provides the values for identifying the individual recording layers provided on one side of the optical disk with guide layer 111. To be specific, “0” is assigned to the recording layer closest to the guide layer, and a value progressively incremented by “1” is assigned to each of the other recording layers progressively away from the guide layer. It is possible to apply the reverse order, where “0” is assigned to the recording layer farthest away from the guide layer, and a value progressively incremented by “1” is assigned to each of the other recording layers progressively toward the guide layer. The former is adopted in this embodiment.

The logical address is a value calculated from the physical address (sector number) and recording layer information recorded in the guide track in the guide layer when user data is recorded to the recording layer. When user data is played back from the recording layer, the logical address is reverse-converted to the physical address (sector number) and recording layer information using the reverse conversion equation.

### [Disk Transfer Mechanism 20]

The disk transfer mechanism 20 is a mechanism that removes the target optical disk 11 from the storage unit 10 and loads it into a disk drive 31 in the drive unit 30, or returns to the storage unit 10 the optical disk 11 ejected from the disk drive 31.

Ideally the disk transfer mechanism 20 has multiple transfer mechanisms that can be operated independently, so that multiple optical disks 11 can be removed from the storage unit 10 simultaneously and loaded separately into multiple disk drives 31 in the drive unit 30, for example.

### [Drive Unit 30]

The drive unit 30 has multiple disk drives 31 installed in it. In the example of this figure, five disk drives 31 are installed. The number of optical disks 11 stored in the storage unit 10 need not be the same as the number of disk drives 31 installed in the drive unit 30.

### (Structure of Disk Drive 31)

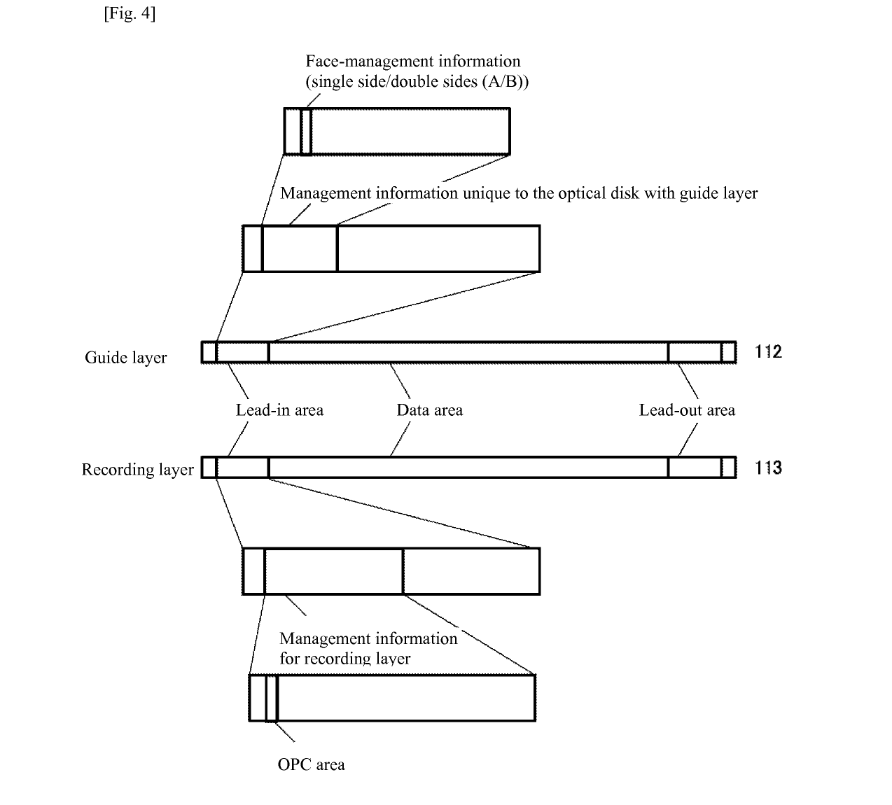

FIG. 5 is a drawing showing the structure of the disk drive 31 being an optical recording device. This disk drive 31 has an optical pickup 32. The optical pickup 32 has a recording/playback optical system corresponding to the recording/playback light, and a guide optical system corresponding to the guide light.

The recording/playback optical system comprises a first light source 33, first collimator lens 34, first polarizing beam splitter 35, first relay lens 36, second collimator lens 37, synthesizing prism 38, ¼ wavelength plate 39, objective lens 60, first light receiving lens 61, and first light receiving part 62, among others. Here, the synthesizing prism 38, ¼ wavelength plate 39, and objective lens 60 belong to both the recording/playback optical system and the guide optical system explained later.

The first light source 33 has a laser diode that emits a laser light of first wavelength as the recording/playback light R1. The recording/playback light R1 emitted from the first light source 33 is converted by the first collimator lens 34 to a parallel light which then travels through the first polarizing beam splitter 35, first relay lens 36, and second collimator lens 37, and enters the synthesizing prism 38. The synthesizing prism 38 synthesizes the recording/playback light R1 entering from the second collimator lens 37 with the guide light R2 of second wavelength entering from a third collimator lens that belongs to the guide optical system described later, in such a way that the optical axes of the two correspond to each other, and causes the synthesized light to enter the objective lens 60 via the ¼ wavelength plate 39. The entered recording/playback light is condensed by the objective lens 60 so that it focuses on the target recording layer 113 (FIG. 3) of one optical disk with guide layer 111 constituting the optical disk 11 which is a double-sided disk.

The recording/playback light (return light) that has been reflected by the recording layer 113 enters the synthesizing prism 38 via the objective lens 60 and ¼ wavelength plate 39, transmits through the synthesizing prism 38 in the direction of entry, and returns to the first polarizing beam splitter 35 via the second collimator lens 37 and first relay lens 36. The first polarizing beam splitter 35 reflects the return light of first wavelength from the first relay lens 36 at an angle of approx. 90 degrees and causes it to enter the first light receiving part 62 via the first light receiving lens 61.

The first light receiving part 62 has a light receiving element whose light receiving surface is divided vertically and horizontally into a total of four, for example, and outputs, as a playback signal, a voltage signal of a level appropriate for the light receiving intensity of each division of the light receiving surface.

The guide optical system (first guide optical system and second guide optical system) comprises a second light source 63, third collimator lens 64, second polarizing beam splitter 65, second relay lens 66, fourth collimator lens 67, synthesizing prism 38, ¼ wavelength plate 39, objective lens 60, second light receiving lens 68, second light receiving part 69, etc.

The second light source 63 emits the guide light R2 being a red laser light. The guide light R2 emitted from the second light source 63 is converted by the third collimator lens 64 to a parallel light which then travels through the second polarizing beam splitter 65, second relay lens 66, and fourth collimator lens 67, and enters the synthesizing prism 38. As mentioned earlier, the guide light R2 entering the synthesizing prism 38 is synthesized by the synthesizing prism 38 with the recording/playback light R1 of first wavelength entering from the second collimator lens 37 of the recording/playback optical system, in such a way that the optical axes of the two correspond to each other, and the synthesized light is caused to enter the objective lens 60 via the ¼ wavelength plate 39. The entered guide light R2 is condensed by the objective lens 60 so that it focuses on the guide layer 112 (FIG. 3) of one optical disk with guide layer 111 constituting the optical disk 11 which is a double-sided disk.

The guide light R2 (return light) reflected by the guide layer 112 enters the synthesizing prism 38 via the objective lens 60 and ¼ wavelength plate 39, is reflected by the synthesizing prism 38 at an angle of approx. 90 degrees, and returns to the second polarizing beam splitter 65 via the fourth collimator lens 67 and second relay lens 66. The second polarizing beam splitter 65 reflects the return light of the guide light R2 from the second relay lens 66 at an angle of approx. 90 degrees and causes it to enter the second light receiving part 69 via the second light receiving lens 68.

The second light receiving part 69 has a light receiving element whose light receiving surface is divided vertically and horizontally into a total of four, for example, and outputs, as a playback signal, a voltage signal of a level appropriate for the light receiving intensity of each division of the light receiving surface.

Also, the optical pickup 32 has a tracking actuator 70 and focusing actuator (not illustrated) provided in it. The tracking actuator 70, being controlled by the tracking control part 71, moves the objective lens 60 in the radial direction of the disk, or vertically with respect to the optical axis to be specific. The focusing actuator, being controlled by a focus control part not illustrated here, moves the objective lens 60 in the direction of the optical axis.

Also provided in the optical pickup 32 is a first relay lens actuator that moves the first relay lens 36 in the direction of the optical axis so as to switch the recording layer 113 on which to irradiate the recording/playback light, and a second relay lens actuator that moves the second relay lens 66 in the direction of the optical axis, both of which are not illustrated here. The foregoing explained the optical pickup 32.

In addition to the optical pickup 32 mentioned above, the disk drive 31 has a data modulation part 72, first light source drive part 73, second light source drive part 74, equalizer 75, data playback part 76, tracking-error generation part 77, tracking control part 71, physical address playback part 78, disk motor drive part 79, feed mechanism 80, and controller 81, as well as focus control part and relay lens control part (not illustrated here), etc.

The data modulation part 72 modulates the recording data fed from the controller 81 and feeds the modulation signals to the first light source drive part 73.

The first light source drive part 73 generates driving pulses for driving the first light source 33 based on the modulation signals from the data modulation part 72.

The equalizer 75 performs an equalizing process, such as PRML (partial response maximum likelihood), on the playback RF signals from the first light receiving part 62 to generate binary signals.

The data playback part 76 demodulates data from the binary signals output by the equalizer 75 and performs a decoding process, such as error correction, to generate playback data from the demodulated data and feeds it to the controller 81.

The tracking error generation part 77 uses the differential push-pull method, for example, to generate a tracking error signal based on the output of the second light receiving part 69, and feeds the signal to the tracking control part 71.

The tracking control part 71 controls the tracking actuator 70 based on the tracking error signal from the tracking-error generation part 77, and causes the objective lens 60 to move vertically with respect to the optical axis and thereby performs tracking control.

The physical address playback part 78 plays back in the guide track in the guide layer, based on the output of the second light receiving part 69, the management information and physical address (sector number) that have been modulated to wobbles or pit arrays, for example, and feeds the information to the controller 81.

The disk motor drive part 79 feeds driving signals to the disk motor 82 that drives and rotates the optical disk 11 under the control by the controller 81.

The feed mechanism 80 is a mechanism that transfers the optical pickup 32 in the radial direction of the optical disk 11.

The focus control part not illustrated here drives the focusing actuator not illustrated here, either, to move the objective lens 60 in the direction of the optical axis.

The controller 81 (control part) has a CPU (central processing unit), ROM (read only memory) and RAM (random access memory), among others. The controller 81 controls the disk drive 31 as a whole based on the program loaded in the main memory area allocated to the RAM.

Installed in the drive unit 30 are multiple disk drives 31 as described above, which can be controlled independently to simultaneously record and play back information to/from the optical disks 11 loaded in them.

As it is expected to support double-sided disks, the optical recording system 1 in this embodiment has a pair of optical pickups 32, or specifically a first optical pickup (including a first guide light optical system) and second optical pickup (including a second guide light optical system) for each disk drive 31, positioned on one side (front side) and the other side (reverse side) of the optical disk 11, respectively, where the data modulation part 72, first light source drive part 73, second light source drive part 74, equalizer 75, data playback part 76, tracking-error generation part 77, tracking control part 71, physical address playback part 78, feed mechanism 80, focus control part, relay lens control part, etc., are provided for each optical pickup 32. And, the controller 81 is intended to perform general control of the two systems mentioned above.

### [RAID Controller 40]

The RAID (redundant arrays of inexpensive disks) controller 40 performs RAID control, which involves recording data multiple times, or distributing data by means of striping for recording, to one or more disk drives 31 in the drive unit 30, in response to a recoding command, etc., from the host device 50.

Upon receiving a recording or playback instruction from the RAID controller 40, the controller 81 of each disk drive 31 performs controls in such a way as to record or play back data to/from the optical disks with guide layer 111 on both sides of the optical disk 11.

### [Host Device 50]

The host device 50 is the highest-order device that controls this optical recording system 1. The host device 50 may be a personal computer. The host device 50 generates or prepares data to be recorded and feeds to the RAID controller 40 a recording command for this data to be recorded. The host device 50 also feeds to the RAID controller 40 a read command that contains a file name specified by the user, etc., and in response obtains data of the applicable file name from the RAID controller 40.

### [Operation of Optical Recording System 1]

Next, the procedure for generating a data frame to be recorded to the data area of the recording layer is explained as a representative operation of the optical recording system 1 in this embodiment.

First, the controller 81 of the disk drive 31 generates ID (identification data) to be added to the data frame shown in FIG. 6. In generating this ID, the controller 81 couples the disk layer number information corresponding to the number of disk layers specified beforehand by the host device 50, with the recording layer identifier (layer information) corresponding to the target recording layer, to generate sector information. It should be noted that this embodiment assumes a multi-layer disk where four recording layers are provided on one side.

Next, the controller 81 generates a logical address as the other constituent of ID, as follows.

Here, the logical address generation process is explained in detail. FIG. 8 is a drawing showing the relationships between the physical addresses in the data area of the guide layer on one hand, and the logical addresses assigned to the data area of each recording layer on the other. In FIG. 8, the solid lines represent the physical addresses in the data area of the guide layer, while the dotted line represents the logical addresses assigned to the data areas of four recording layers. The four recording layers are denoted as recording layer L0, recording layer L1, recording layer L2, and recording layer L3, respectively, from the one closest to the guide layer. User data is recorded to the four recording layers in the order of L0, L1, L2, and L3, and that user data is recorded in each individual recording layer in the direction from the inner periphery toward the outer periphery.

Since the physical address space in the data area of the guide layer is limited to the size of the data area of one recording layer, the space can only be assigned to the logical addresses in the data area of one recording layer, as is. Accordingly, in this embodiment the logical addresses in the data areas of all recording layers as represented by the dotted line are obtained by calculations, based on the physical address and recording layer information in the guide layer.

To be specific, these calculations are performed using the equation LSN=(PSN_max*x)+PSN - - - (1), where PSN_max represents the largest physical address in the guide layer (final physical address), x represents the recording layer information of recording layer Lx (x=0, 1, 2, etc.), PSN represents the physical address corresponding to the target recording position in the data area of recording layer Lx, and LSN represents the logical address assigned to each data that has been recorded at the target recording position in the data area of recording layer Lx.

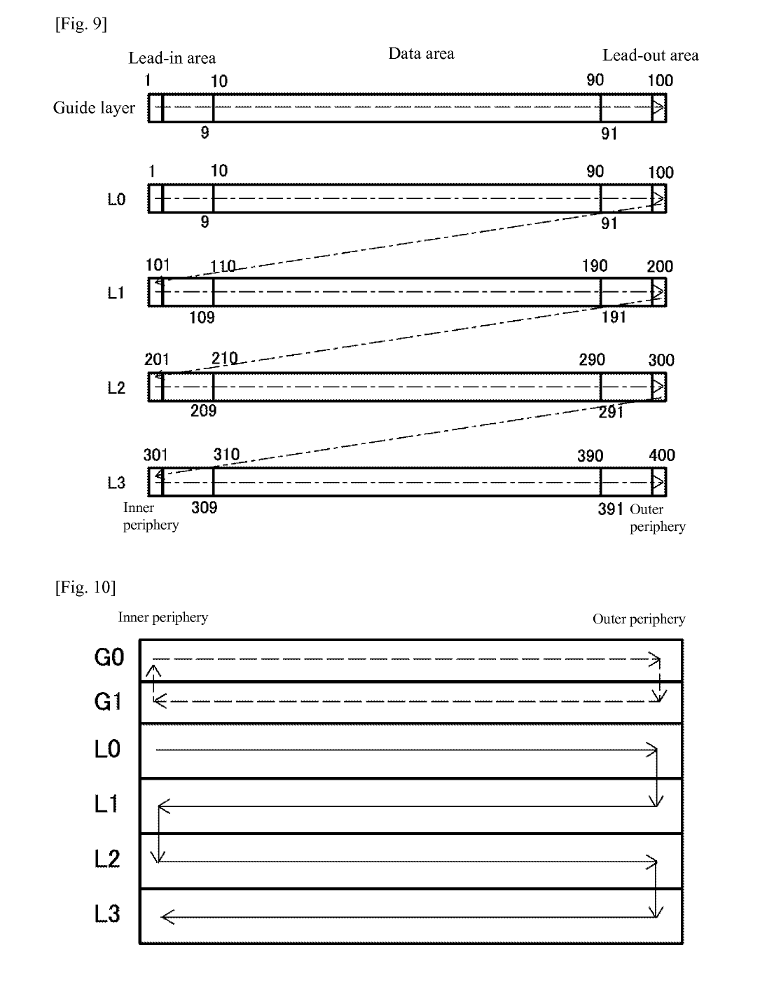

FIG. 9 is a drawing showing the specific assignments of logical addresses. For example, assume that the physical addresses “1” to “100” are assigned to the guide layer from the inner periphery side, and that the head physical address in the data area of the guide layer is “10” and the final physical address in the data area of the guide layer is “90.” It should be noted that these physical address values are nothing but convenient values determined for illustration purposes.

In the calculation of logical address LSN according to Equation (1), the calculation result of (100*0)+PSN gives the logical address for the data area of recording layer L0 (x=0), which means that the physical addresses “10” to “90” in the data area of the guide layer are directly assigned as logical addresses for the data area of recording layer L0. Since the calculation result of (100*1)+PSN gives the logical address for the data area of recording layer L1 (x=1), “110” to “190” are assigned as logical addresses for the data area of recording layer L1. Since the calculation result of (100*2)+PSN gives the logical address for the data area of recording layer L2 (x=2), “210” to “290” are assigned as logical addresses for the data area of recording layer L2. Since the calculation result of (100*3)+PSN gives the logical address for the data area of recording layer L3 (x=3), “310” to “390” are assigned as logical addresses for the data area of recording layer L3.

To read the user data from the recording layer, the logical address (LSN) specified by the host device 50 is divided by the largest physical address (PSN_MAX) in the guide layer. The quotient value obtained by this calculation gives the recording layer information (x), and the remainder represents the physical address (PSN).

After the logical address has been generated as explained above, the controller 81 merges the generated sector information and logical address to generate ID. Next, the controller 81 adds the error detection code for this ID, user data, and error detection code, to generate a data frame. Furthermore, the controller 81 scrambles the data frame, generates an ECC block and performs interleaving, and feeds the result to the data modulation part 72 as data to be recorded.

The data modulation part 72 modulates the data to be recorded using the 8/16 conversion code and other recoding codes, and feeds the modulation signals to the first light source drive part 73. The first light source drive part 73 feeds drive pulses to the first light source 33 based on the modulation signals from the data modulation part 72. This way, the recording/playback light R1 is emitted from the first light source 33 and the user data is recorded to the data area of the recording layer in the optical disk with guide layer 111.

### [Effects]

With the optical recording system 1 in this embodiment, logical addresses in the data areas of multiple recording layers are generated by calculations from the physical addresses and recording layer information in the guide layer. As a result, the manufacturing yield of multi-layer disks can be improved over the method of recording physical addresses beforehand in individual recording layers in the forms of wobbles or pit arrays and then utilizing these physical addresses to generate logical addresses for each recording layer. To be specific, in the case of optical disks with physical addresses recorded in each recording layer in the forms of wobbles, pre-pits, etc., those disks having even a single recording layer that generates a physical address read error must be judged defective and scrapped. This means that increasing the number of recording layers to be stacked increases the percent defective of such multi-layer disks; while in this embodiment, all that is required is to read the physical addresses from the guide layer, and consequently the number of recording layers can be increased relatively easily and the manufacturing yield is also expected to improve.

### Second Embodiment

Next, the second embodiment of the present invention is explained. In the first embodiment described above, the recording direction is the same, or specifically from the inner periphery toward the outer periphery, for all of the multiple recording layers. This means that, when accessing consecutively from a given recording layer to a different recording layer, the optical pickup must be moved at once (jumped) from an outer periphery position to an inner periphery position in the data area, which results in lost time corresponding to this movement. For this reason, a method of providing two guide layers, each spiraling in an opposite direction, is considered.

As shown in FIG. 10, this method can prevent the optical pickup from having to jump a long distance and consequently avoid the aforementioned lost time when accessing user data recorded consecutively across adjacent recording layers, by setting the spiraling direction of the guide track in guide layer G0 as “Inner Outer” and that of the guide track in guide layer G1 as “Outer Inner.”

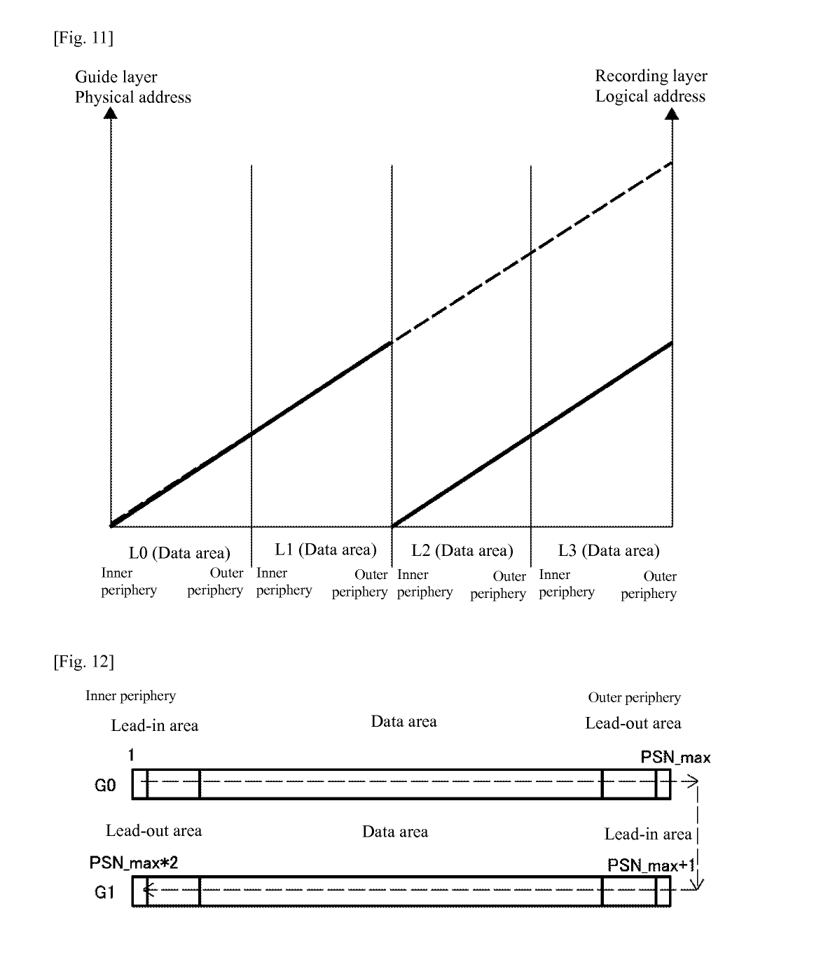

The present invention can also be applied when such method is used. FIG. 11 is a drawing showing the relationships between the physical addresses in the data areas of two guide layers G0, G1 on one hand, and the logical addresses assigned to the data areas of four recording layers L0, L1, L2, L3 on the other. FIG. 12 is a drawing showing the physical addresses assigned to two guide layers G0, G1.

Guide layer G0 records the physical addresses “1” to “PSN_max” consecutively from the inner periphery toward the outer periphery, while guide layer G1 records the physical addresses “PSN_max+1” to “PSN_max*2” consecutively in the opposite direction from the outer periphery toward the inner periphery.

In this case, the logical addresses assigned to each recording layer are calculated by LSN0=(PSN_max*x)+PSN0 - - - (2) and LSN1=(PSN_max*(x−1))+PSN1 - - - (3), where PSN_max represents the largest physical address in guide layer G0, x represents the recording layer information of recording layer Lx (x=0, 1, 2, etc.), PSN0 represents the physical address in guide layer G0 corresponding to the target recording position in the data area of even-numbered recording layer Lx (x=0, 2, etc.), PSN1 represents the physical address in recording layer G1 corresponding to the target recording position in the data area of odd-numbered recording layer Lx (x=1, 3, etc.), LSN0 represents the logical address given to each data recorded at the target recording position in the data area of even-numbered recording layer Lx (x=0, 2, etc.), and LSN1 represents the logical address given to each data recorded at the target recording position in the data area of odd-numbered recording layer Lx (x=1, 3, etc.).

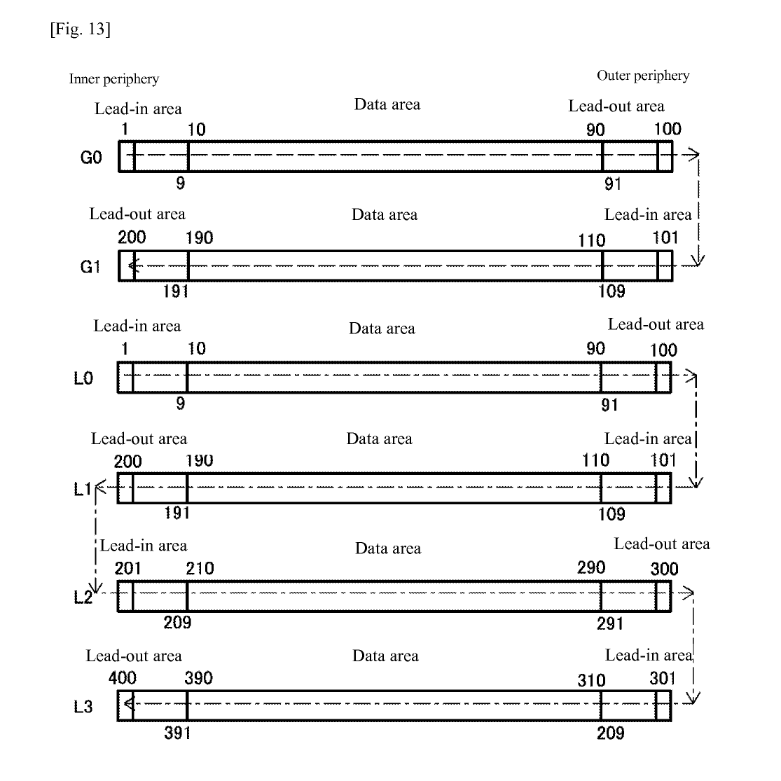

FIG. 13 is a drawing showing the specific assignments of logical addresses in the second embodiment. For example, the physical addresses “1” to “100” are recorded consecutively in guide layer G0 from the inner periphery toward the outer periphery, while the physical addresses “101” to “200” are recorded consecutively in the other guide layer G1 in the opposite direction from the outer periphery toward the inner periphery.

In the calculation of logical addresses LSN0 and LSN1 according to Equation (2) and Equation (3), the calculation result of (100*0)+PSN0 gives the logical address for the data area of recording layer L0 (x=0), which means that the physical addresses “10” to “90” in the data area of guide layer G0 are directly assigned as logical addresses for the data area of recording layer L0. Since the calculation result of (100*(1−1))+PSN1 gives the logical address for the data area of recording layer L1 (x=1), “110” to “190” are assigned as logical addresses for the data area of recording layer L1. Since the calculation result of (100*2)+PSN0 gives the logical address for the data area of recording layer L2 (x=2), “210” to “290” are assigned as logical addresses for the data area of recording layer L2. Since the calculation result of (100*(3−1))+PSN1 gives the logical address for the data area of recording layer L3 (x=3), “310” to “390” are assigned as logical addresses for the data area of recording layer L3.

As explained above, according to this embodiment it is also possible to assign consecutive logical addresses to the data areas of all recording layers, based on calculations, from the physical addresses and recording layer information in the guide layers. Also according to this embodiment, the optical pickup no longer jumps a long distance when accessing user data recorded consecutively across adjacent recording layers, and therefore lost time that would otherwise generate from a long-distance jump can be avoided.

### Third Embodiment

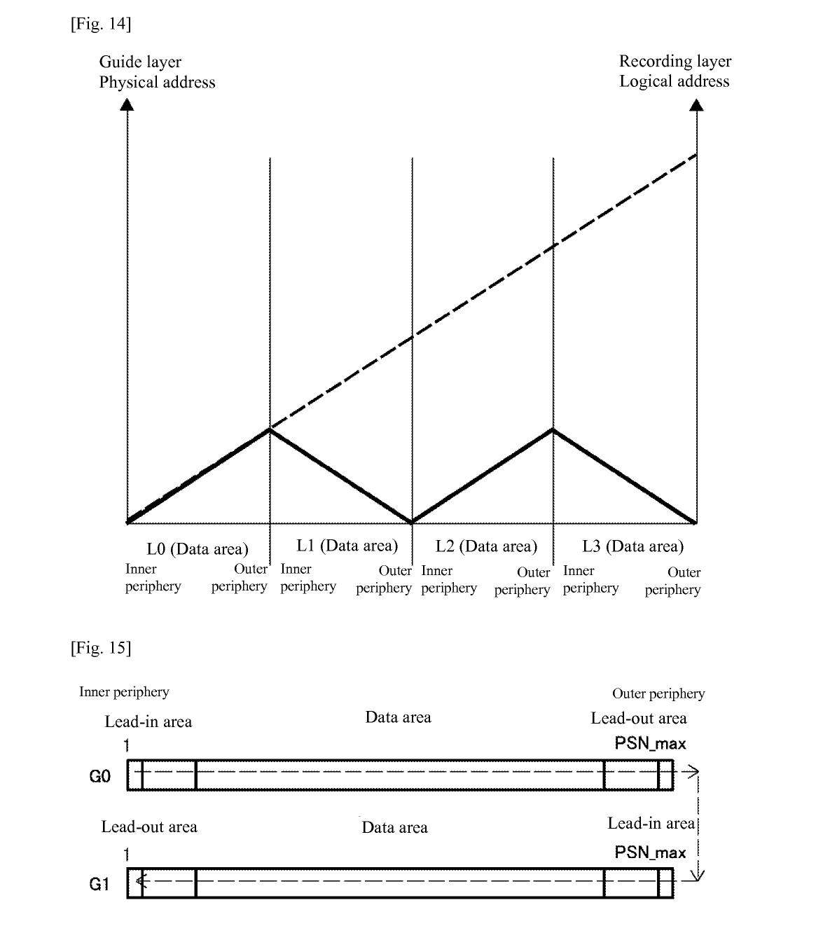

Next, the third embodiment of the present invention is explained. In the second embodiment, a case where physical addresses recorded in the two guide tracks in two guide layers G0, G1 would increase in the spiraling directions of the tracks, respectively, was illustrated. However, the present invention can also be applied to a case as shown in FIG. 14, where physical addresses recorded in the guide track in guide layer G0 would increase in the spiraling direction in one physical address space, while in contrast the values of physical addresses recorded in the guide track in guide layer G1 would decrease in the spiraling direction in the same physical address space.

FIG. 14 is a drawing showing the relationships between the physical addresses in the data areas of two guide layers G0, G1 on one hand, and the logical addresses assigned to the data areas of recording layers L0, L1, L2, L3 on the other, in this embodiment. FIG. 15 is a drawing showing the physical addresses assigned to two guide layers G0, G1.

The physical addresses “1” to “PSN_max” are recorded consecutively in one guide layer G0 used first, from the inner periphery toward the outer periphery, while the physical addresses “PSN_max” to “1” are recorded consecutively in the data area of guide layer G1 from the outer periphery toward the inner periphery.

In this case, the logical addresses assigned to each recording layer are calculated by LSN0=(PSN_max*x)+PSN0 - - - (4) and LSN1=(PSN_max*x)+PSN_max−PSN1+1 - - - (5).

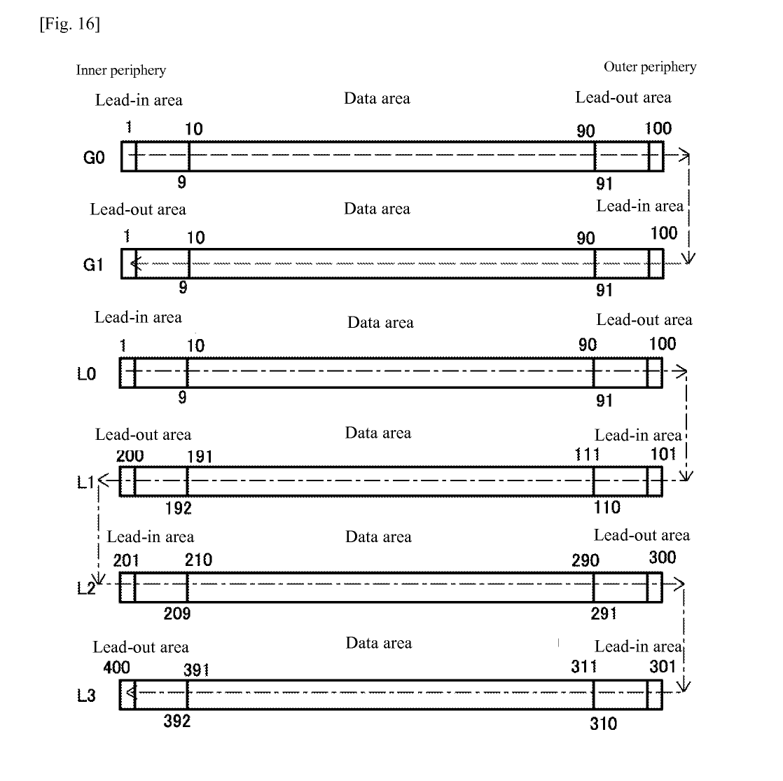

FIG. 16 is a drawing showing the specific assignments of logical addresses in the third embodiment. For example, the physical addresses “1” to “100” are recorded consecutively in guide layer G0 from the inner periphery toward the outer periphery, while the physical addresses “100” to “1” are recorded consecutively in the other guide layer G1 in the opposite direction from the outer periphery toward the inner periphery.

In the calculation of logical addresses LSN0 and LSN1 according to Equation (4) and Equation (5), the calculation result of (100*0)+PSN0 gives the logical address for the data area of recording layer L0 (x=0), which means that the physical addresses “10” to “90” in the data area of guide layer G0 are directly assigned as logical addresses for the data area of recording layer L0. Since the calculation result of (100*1)+100−PSN1+1 gives the logical address for the data area of recording layer L1 (x=1), “111” to “191” are assigned as logical addresses for the data area of recording layer L1. Since the calculation result of (100*2)+PSN0 gives the logical address for the data area of recording layer L2 (x=2), “210” to “290” are assigned as logical addresses for the data area of recording layer L2. Since the calculation result of (100*3)+100−PSN1+1 gives the logical address for the data area of recording layer L3 (x=3), “311” to “391” are assigned as logical addresses for the data area of recording layer L3.

As explained above, according to this embodiment it is also possible to assign consecutive logical addresses to the data areas of all recording layers, based on calculations, from the physical addresses and recording layer information in the guide layers. Also according to this embodiment, again the optical pickup no longer jumps a long distance when accessing user data recorded consecutively across adjacent recording layers, and therefore lost time that would otherwise generate from a long-distance jump can be avoided.

It should be noted that the present invention is not limited to the aforementioned embodiments, and various changes can be made to the extent that doing so does not deviate from the key points of the present invention.

### DESCRIPTION OF THE SYMBOLS

1 - - - Optical recording system, 30 - - - Drive unit, 31 - - - Disk drive, 32 - - - Optical pickup, 78 - - - Physical address playback part, 81 - - - Controller, 111 - - - Optical disk with guide layer, 112 - - - Guide layer, 113 - - - Recording layer

1. An optical recording device for recording to a disk that has at least one guide layer with a guide track where physical address information is recorded, and multiple recording layers where data is recorded according to the guide track, said optical recording device having a physical address playback part that obtains the physical address information from the guide track in the guide layer, as well as a control part that uses the obtained physical address information and information identifying each of the recording layers to calculate a logical address to be assigned to each data recorded to the recording layer.

2. An optical recording device according to claim 1, wherein the control part calculates LSN using an equation LSN=(PSN_max*x)+PSN, where PSN_max represents a largest physical address recorded in the guide tracks, x represents an information identifying recording layer Lx (x=0, 1, 2, etc., assigned in this order from the recording layer closest to or farthest away from the guide layer), PSN represents a physical address corresponding to a target recording position in a data area of recording layer Lx, and LSN represents a logical address assigned to each data that has been recorded at the target recording position in the data area of recording layer Lx.

3. An optical recording device according to claim 1, wherein the guide layer comprises a first guide layer having a first guide track and a second guide layer having a second guide track that spirals in a direction opposite a spiraling direction of the first guide track, where one physical address space is assigned to both the first guide track and second guide track combined, with the physical addresses recorded in the first guide track marking a starting side, and the control part calculates LSN0 and LSN1 using equations LSN0=(PSN_max*x)+PSN0 and LSN1=(PSN_max*(x−1))+PSN 1, respectively, where PSN_max represents a largest physical address recorded in the first guide track, x represents an information identifying recording layer Lx (x=0, 1, 2, etc., assigned in this order from the recording layer closest to or farthest away from the first guide layer), PSN0 represents a physical address in the first guide track corresponding to a target recording position in a data area of even-numbered recording layer Lx (x=0, 2, etc.), PSN1 represents a physical address in the second guide track corresponding to a target recording position in a data area of odd-numbered recording layer Lx (x=1, 3, etc.), LSN0 represents a logical address given to each data recorded at the target recording position in the data area of even-numbered recording layer Lx (x=0, 2, etc.), and LSN1 represents a logical address given to each data recorded at the target recording position in the data area of odd-numbered recording layer Lx (x=1, 3, etc.).

4. An optical recording device according to claim 1, wherein the guide layer comprises a first guide layer having a first guide track and a second guide layer having a second guide track that spirals in a direction opposite a spiraling direction of the first guide track, where physical addresses recorded in the first guide track increase in the spiraling direction in one physical address space, while physical addresses recorded in the second guide track decrease in the spiraling direction in the physical address space, and the control part calculates LSN0 and LSN1 using equations LSN0=(PSN_max*x)+PSN0 and LSN1=(PSN_max*x)+PSN_max−PSN1+1, respectively, where PSN_max represents a largest physical address recorded in the first guide track, x represents an information identifying recording layer Lx (x=0, 1, 2, etc., assigned in this order from the recording layer closest to or farthest away from the first guide layer), PSN0 represents a physical address in the first guide track corresponding to a target recording position in a data area of even-numbered recording layer Lx (x=0, 2, etc.), PSN1 represents a physical address in the second guide track corresponding to a target recording position in a data area of odd-numbered recording layer Lx (x=1, 3, etc.), LSN0 represents a logical address given to each data recorded at the target recording position in the data area of even-numbered recording layer Lx (x=0, 2, etc.), and LSN1 represents a logical address given to each data recorded at the target recording position in the data area of odd-numbered recording layer Lx (x=1, 3, etc.).

5. A method of recording to a disk having at least one guide layer with a guide track where physical address information is recorded, and multiple recording layers where data is recorded according to the guide track, said optical recording method comprising:
obtaining a physical address information from the guide track in the guide layer,
calculating a logical address to be assigned to each data recorded to the recording layer, using the obtained physical address information and information identifying each of the recording layers,
recording the logical address to the recording layer, and
managing data recording using the logical address recorded in the recording layer, thereby recording desired data to the disk.

6. An optical recording device for recording to a disk that has at least one guide layer with a guide track where physical address information is recorded, and multiple recording layers where data is recorded according to the guide track, said optical recording device comprising:
a physical address playback part programmed to obtain the physical address information from the guide track in the guide layer; and
a control part that comprises a CPU (central processing unit), ROM (read only memory) and RAM (random access memory), and that is programmed to calculate a logical address to be assigned to each data recorded to the recording layer, based on the obtained physical address information and information identifying each of the recording layers, said logical address being consecutive with respect to data areas of all of the recording layers.
